(19) United States
(12) Patent Application Publication
(10) Pub. No.: US 2024/0004625 A1
(43) Pub. Date: Jan. 4, 2024

(54) SYSTEMS, METHODS, AND SOFTWARE FOR PERFORMANCE-BASED FEATURE ROLLOUT

(71) Applicant: Microsoft Technology Licensing, LLC, Redmond, WA (US)

(72) Inventors: Prerana Dharmesh GAMBHIR, San Jose, CA (US); Sharena Meena PARI-MONASCH, Union City, CA (US); Yongchang DONG, San Jose, CA (US); Thanh Trung NGUYEN, Bellevue, WA (US); Shmuel NAVON, Sunnyvale, CA (US); Qiong ZHOU, Cupertino, CA (US); Yiming SHI, Milpitas, CA (US); Linh Phuong NGUYEN, San Francisco, CA (US); Xiao LIANG, Bellevue, WA (US); Christopher Robert HAYWORTH, Martinez, CA (US); Daniel Ming-Wei CHEUNG, San Francisco, CA (US)

(21) Appl. No.: 17/852,926

(22) Filed: Jun. 29, 2022

(51) Int. Cl. G06F 8/60; G06F 8/71; G06F 11/34; G06F 8/77

(52) U.S. Cl. CPC G06F 8/60; G06F 8/71; G06F 11/3409; G06F 8/77; G06F 2201/865

(57) ABSTRACT

Various embodiments of the present technology include an improved system for measuring the impacts of feature rollouts on machine utilization and service performance. More specifically, embodiments of the present technology include an exposure control system based on randomized machine assignments and a corresponding score card for comparing machine utilization metrics. In an embodiment, a computing apparatus identifies a new feature in a codebase, wherein the codebase has been updated with the new feature across multiple resources, enables the new feature for a target group of the multiple resources while keeping the new feature dormant for a control group of the multiple resources, collects performance information for the target group and the control group for a time period, and generates a visualization of one or more differences between the performance information for the target group and the performance information for the control group for the time period.

### BACKGROUND

Servers are machines built to store, process, and manage network data, devices, and systems. Client devices may communicate with servers to receive resources from them or to perform certain tasks that may be unfeasible, inefficient, or too expensive to host on the client. In many scenarios, a single server may host multiple virtual machines (VMs), which are accessed by client devices and used to provide the aforementioned resources or services, as an alternative to requiring an entire physical host machine for given tasks. As servers are used more efficiently in this way, they tend to operate closer to maximum capacity for purposes of reducing the expense.

Machine utilization, including capacity optimization and load balancing, is an important factor that greatly impacts quality of service (QoS) provided by servers and has direct influence on the cost of goods sold (COGS). While increasing machine utilization can decrease COGS, it can also cause performance issues, negatively impacting QoS. Performance changes are difficult to measure with existing exposure control systems, in part because they are user-based.

Performance analytics for new feature rollouts that could potentially affect COGS and QoS are measured based on dates before and after implementing the changes. A feature may be evenly distributed over a large number of servers, or across entire data centers. The effect of these rollouts can therefore be masked by spikes, drops, or seasonal changes in traffic. Moreover, data centers already have different utilization levels, making it difficult to compare utilization between data centers. Thus, existing rollout methods make measurements on single machines or comparisons between datacenters unreliable.

### OVERVIEW

Various embodiments of the present technology generally relate to development tools and an improved system for measuring the impacts of feature rollouts on machine utilization and service performance. More specifically, embodiments of the present technology include an exposure control system based on randomized machine assignments and a corresponding score card for comparing machine utilization metrics. In an embodiment of the present technology, a computing apparatus comprises one or more computer readable storage media, one or more processors operatively coupled with the one or more computer readable storage media, and program instructions stored on the one or more computer readable storage media. The program instructions, when executed by the one or more processors, direct the computing apparatus to at least: identify a new feature in a codebase, wherein the codebase has been updated with the new feature across multiple resources; enable the new feature for a target group of the multiple resources while keeping the new feature dormant for a control group of the multiple resources; collect performance information for the target group and the control group for a time period; and generate a visualization of one or more differences between the performance information for the target group and the performance information for the control group for the time period.

In some embodiments, the program instructions further direct the computing apparatus to identify the target group and the control group from amongst the multiple resources. The program instructions, to identify the target group and the control group from amongst the multiple resources, may further direct the computing apparatus to randomly select one or more resources from the multiple resources for the target group. In certain embodiments, the program instructions further direct the computing apparatus to receive, via a user interface, an instruction to deploy the new feature in a remainder of the resources, wherein the remainder of the resources comprises resources of the multiple resources that were not a part of the target group.

In some embodiments, the performance information comprises machine utilization statistics for each resource in the target group. In accordance with this embodiment, the program instructions may further direct the computing apparatus to provide the performance information for the target group and the control group to one or more machine learning models, wherein the one or more machine learning models are configured to generate a recommendation for improving the new feature based at least on the machine utilization statistics. Moreover, the program instructions may further direct the computing apparatus to surface, in a user interface, the recommendation for improving the new feature. In some scenarios, the feature affects two or more services that utilize the codebase, and the target group is spread across resources that provide a first service of the two or more services and a second service of the two or more services.

This Overview is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrate an example of an exposure control environment in which some embodiments of the present technology may be implemented.

FIG. 2 illustrates a series of steps for applying machine-based exposure control functionality in accordance with some embodiments of the present technology.

FIG. 3 illustrates an example of exposure control system functionality in accordance with some embodiments of the present technology.

FIGS. 4A-4B illustrate examples of score cards for analyzing machine utilization metrics in accordance with some embodiments of the present technology.

FIG. 5 illustrates an example operational scenario in accordance with some embodiments of the present technology.

FIG. 6 illustrates a series of steps for rolling out a new feature in accordance with some embodiments of the present technology.

FIG. 7 illustrates a series of steps for enabling a new feature in accordance with some embodiments of the present technology.

FIG. 8 illustrates an example of a computing device that may be used in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to development tools and an improved system for monitoring the impacts of feature rollouts on machine utilization and service performance. More specifically, embodiments of the present technology include an exposure control system that is based on randomized machine assignments and a corresponding score card for comparing machine utilization metrics. The machine-based exposure control system described herein serves as an end-to-end solution for determining how a new feature affects services (e.g., virtual machine cores) and quantifying the COGS impact of the feature. In accordance with the technology described herein, features may be turned on for individual machine (e.g., server or virtual machine), such that accurate machine-to-machine comparisons can be made.

Machine utilization is a major factor in quality of service (QoS) and has direct consequences on the cost of goods sold (COGS) if used inefficiently. Optimizing the usage of machines (e.g., servers or virtual machines) can reduce COGS while maintaining or improving QoS. However, COGS and performance (i.e., system resource utilization) improvements are difficult to measure with current exposure control systems because the exposure control systems are primarily user-based. Features may be rolled out based on users or sessions, and may be evenly distributed over the machines, making it difficult to see any impact on particular machines. In other instances, new features may be rolled out for an entire data center and analysts may try to measure the effects of the rollout by comparing two difference data centers. Date-based rollouts, however, are affected by seasonal changes in traffic, which can make dates consistently less reliable, and utilization levels at different data centers differ greatly depending on geography and similar factors, making it difficult to compare utilization using these methods. For both date and data center rollouts, there is also the problem of not being able to rollout multiple fixes at the same time.

Thus, the present technology includes an exposure control system that uses randomized machine assignments and a corresponding score card for comparing machine utilization metrics. The randomized machine-based rollout system herein allows for accurate measurements of changes in utilization, performance metrics, and the ability to rollout multiple fixes or features at the same time. The improved system allows developers to monitor the impact of a feature rollout, how the feature is performing on a service, and how it is affecting other services (e.g., datacenter cores) in order to quantify metrics relevant to COGS. A scorecard, in accordance with the present disclosure, includes clear metrics that help identify problems and analyze the impact of a given rollout for more accurately measuring the COGS impact of the rollout. The scorecard provides performance information that can be useful even to those unfamiliar with the machine utilization data itself.

Some embodiments of the present technology include the use of machine learning models to interactively advise developers on how a feature is performing on a service (e.g., VM cores) relative to other services and highlight opportunities for improvement and/or regressions. Moreover, in some embodiments, the machine-based utilization exposure control system discussed herein may be implemented as an end-to-end public facing DevOps service that provides the benefits described herein. In embodiments herein, the exposure control system is integrated with other DevOps functionality such that an engineering and/or program manager team can plan a feature rollout and monitor the rollout themselves as they work through the feature development. In accordance with this embodiment, changes can be made for different access levels (e.g., rings) so that impacts from a new rollout affect fewer end users. For example, a change may be enabled at only the program manager level, for an entire enterprise, or for the general public. In this way, if the change negatively affects performance, only the exposed group (e.g., enterprise personnel) will be affected by the issues.

Various technical effects may be appreciated from the implementations disclosed herein, including increasing machine utilization without negatively impacting the quality of service. Additionally, technical effects that may be appreciated from the implementations herein include a reduction in COGS, improvements in performance associated with feature rollouts, a reduction in time needed to analyze the effects of feature rollouts, and a reduction in downtime associated with errors in feature rollouts. Technical effects further include the ability to receive information and feedback (real-time, near real-time, or batch) from a machine. Another technical effect of the present technology is the ability to roll out multiple features at the same time without compromising the ability to analyze the QoS and COGs impact of the individual features.

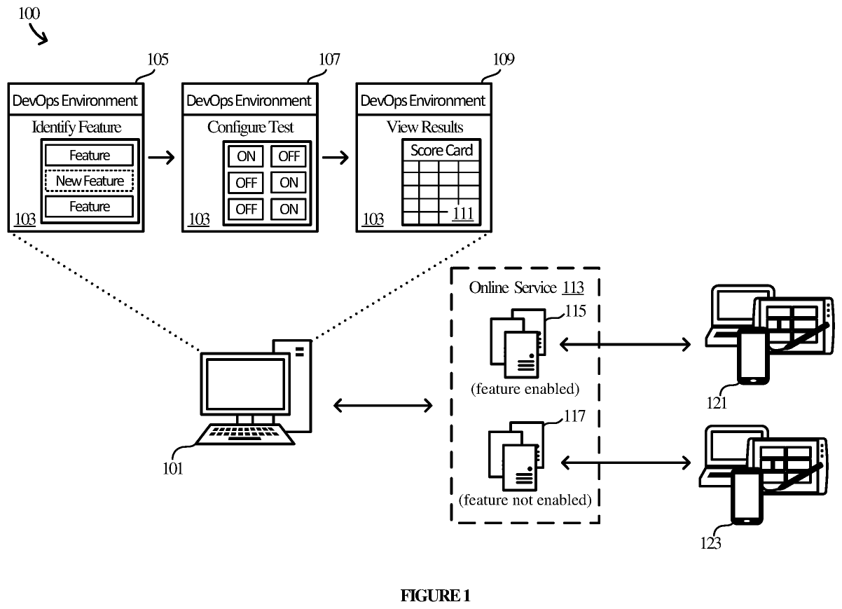

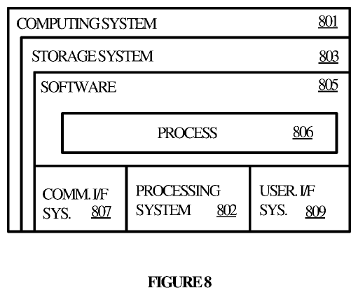

Referring now to the drawings, FIG. 1 illustrates exposure control environment 100 in an implementation. Exposure control environment 100 includes computing device 101, with which a user may interact in the context of an application and its features and functionality. Examples of computing device 101 include personal computers, tablet computers, mobile phones, and any other suitable device, of which computing system 801 in FIG. 8 is broadly representative.

Computing device 101 includes one or more development or operations (or DevOps) software applications in which a user can open, edit, or create program instructions, as well as add feature specifications, add rollout information, configure machine functionality, and view exposure control test results. The one or more software applications may include natively installed and executed applications, browser-based applications, mobile applications, or any other applications suitable for development, operations, program managing, exposure control functionality, and the like. Software applications on computing device 101 may execute in a stand-alone manner (as in the case of a natively installed application), within the context of another application (as in the case of a browser-based application, in an online collaborative context, in a combination of contexts, or in some other manner entirely.

In accordance with the present disclosure, computing device 101, running one or more of the previously discussed software applications, displays environment 103 in a user interface of computing device 101. Environment 103 is representative of a software environment in which developers and/or operations personnel develop and manage software applications. It may be appreciated that, while illustrated as a single environment, the developer and operations tools provided by environment 103 could be distributed between or amongst multiple environments.

In operation 105, computing device 101 identifies a new feature for one or more online services. In accordance with the present example, a new feature may be created, edited, added, or similar within environment 103. Once the new feature is created, edited, added, or similar, the update may be communicated and committed to a native executable file for the online service. In an exemplary embodiment, the update is sent to all machines, and can then be turned on (or off) for individual machines.

In operation 107, computing device 101 configures a test of the new feature in environment 103 by enabling the feature on a subset of machines (i.e., the “target” machines), wherein the target machines, in an exemplary embodiment, are virtual machines (VMs) making up all or a portion of online service 113. In certain examples, the target machines are randomly selected from all available machines that provide the online service. In other examples, the subset of machines is defined or chosen by the user of computing device 101 or another user operating on a different device. In any case, upon configuring the target machines on which the new feature is enabled, the feature remains disabled or dormant on all other machines that are not a part of the target group. In accordance with the present example, the new feature may be enabled or disabled for individual machines, groups of machines, or all machines from computing device 101.

In operation 109, computing device 101 displays results (e.g., machine utilization metrics provided in score card 111) in environment 103 from a test period (i.e., timeframe) and a test location or region (i.e., geography) running the new feature on one or more of the target machines. The results may, in some examples, include metrics for, or a comparison to, a “control” group of machines on which the new feature remained dormant. The control group is, in some examples, a randomly selected group of machines to which the target group can be compared. In other examples, a user of computing device 101, or another user operating on a different device, selects the control group.

Exposure control environment 100 further includes end user devices 121 and end user devices 123. End user devices 123 and end user devices 123 are representative of any computing devices with which a user may interact in the context of an end user application and its features and functionality. Examples of end user devices 121 and end user devices 123 include personal computers, tablet computers, mobile phones, and any other suitable devices, or which computing system 801 in FIG. 8 may be broadly representative.

End user devices 121 and end user devices 123 include one or more software applications. Examples of software applications include, but are not limited to, spreadsheet applications, word processing applications, digital notebook applications, email applications, and workflow automation applications. Applications may be a natively installed and executed, browser-based applications, mobile application, or any other applications suitable for end user devices 121 or end user devices 123. Software applications may execute in a stand-alone manner (as in the case of a natively installed application), within the context or another application (as in the case of a browser-based application), in an online collaborative context, in a combination of contexts, or in some other manner entirely.

In an example, end user devices 121 and end user devices 123 run at least one productivity application, wherein the productivity application may access online service 113 for execution of one or more tasks within the productivity application. In accordance with the present technology, the new feature is associated with the productivity application and may be enabled or disabled based on whether it is part of a target or control group, or neither. End user devices 121 may use one or more machines from group 115 to execute one or more tasks within the productivity application, wherein machines in group 115 have the feature enabled and may use the new feature in responding to the request. End user devices 123 may use one or more machines from group 117 to execute one or more tasks within the productivity application, wherein machines in group 117 no don have the new feature enabled and do not use the new feature in responding to the request.

Exposure control environment 100 further includes online service 113. Online service 113 provides one or more computing services to end points such as end user devices 121 and end user devices 123. For example, online service 113 may host all or portions of an application running on end user devices 121 or end user devices 123, and all or portions of additional applications. It may therefore be appreciated that some of the features and functionality attributed to the applications running on end user devices 121 and end user devices 123 may be performed by online service 113 in some implementations. Online service 113 may provide a variety of other services including but not limited to other applications, file storage, co-authoring and collaboration support, and the like. In some examples, online service 113 may provide a suite of applications and services with respect to a variety of computing workloads such as office productivity tasks, workflow automation tasks, email, chat, voice and video, and so on.

Online service 113 employs two or more server computers co-located or distributed across one or more data centers. Examples of servers that make up group 115 and group 117 in online service 113 include web servers, application servers, virtual or physical (bare metal) servers, or any combination or variation thereof, of which computing system 801 in FIG. 8 may be broadly representative. End user devices 121 may communicate with online service 113 via one or more internets and intranets, the Internet, wired and wireless networks, local area networks (LANs), wide area networks (WANs), and any other type of network or combination thereof.

Online service 113, in the present example, includes two groups of servers, group 115 and group 117, shown for illustrative purposes wherein group 115 is representative of a subset of servers that are part of a target group for testing the new feature previously discussed, while group 117 is representative of servers that are part of a control group for testing the new feature.

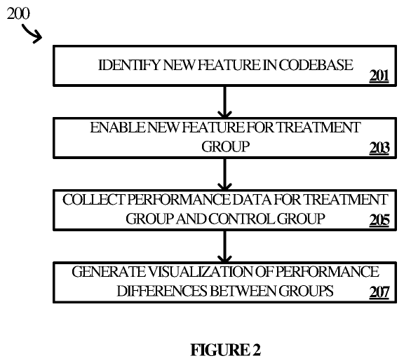

FIG. 2 illustrates process 200 for implementing a machine-based exposure control system as described herein. Process 200 may be implemented in program instructions in the context of any of the software applications, modules, components, or other such elements of one or more computing devices. For example, process 200 may be employed by an application on computing device 101, or by an application running in the context of online service 113. The program instructions direct the one or more computing devices to operate as follows, referring to a computing device in the singular form for purposes of clarity.

In step 201 of process 200, the computing device identifies a new feature (e.g., operation 105) in a codebase. The new feature may be any update to an application that uses an online service (e.g., online service 113) associated with the codebase (e.g., an application running on end user devices 121 or end user devices 123). The application may be an online application (e.g., a browser application) or a native application that uses an online service to perform one or more processes in the application. In an example, the new feature includes a single threaded mode for graphics rendering in a productivity application running on end user devices. In this example, the new feature may change how graphics are rendered in the productivity application from always using a multi-threaded mode to sometimes using a single threaded mode such that the process is simplified and can run on a single core.

In step 203 of process 200, the computing device enables the new feature (e.g., operation 107) for the treatment group (e.g., group 115), wherein the treatment group in the present example is representative of the group of servers for which the new feature is turned on. In addition to the treatment group, a control group (e.g., group 117) may be chosen to which the machine utilization statistics for the treatment group can be compared. The treatment group and control group may be any number of servers, including one, such that the performance of the service with the new feature turned on can be compared to performance of the service without the new feature enabled.

In step 205 of process 200, the computing device collects performance data for the treatment group and the control group. In some examples, the metrics from the machines are reported back to the computing device via a reporting module in the application. Performance data, in accordance with the present example, includes measurements representative of the effect of the new feature on system resource utilization. In step 207, the computing device generates a visualization (e.g., score card 111) of performance differences between the treatment group and the control group (e.g., operation 109). The visualization may be any visual representation of the machine utilization metrics collected from the treatment group and the control group, including but not limited to a table, a graph, a chart, an array, a numerical comparison, and the like.

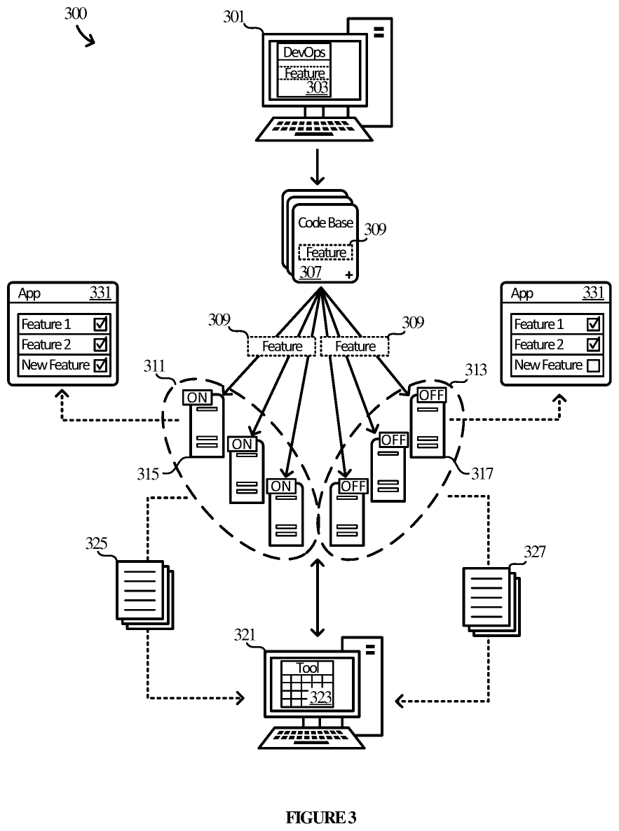

FIG. 3 illustrates exposure control environment 300 in another implementation. Exposure control environment 300 includes computing device 301 and computing device 321, with which users may interact in the context of an application. Examples of computing device 301 and computing device 321 include personal computers, tablet computers, mobile phones, and any other suitable devices, of which computing system 801 in FIG. 8 may be broadly representative.

Computing device 301 includes one or more development or operations (or DevOps) software applications in which a user can open, edit, or create program instructions, configure machine functionality, as shown in environment 303. Computing device 321 includes one or more software applications for viewing and analyzing exposure control test results, as shown by metrics tool 323. In some examples, the applications on computing device 301 and computing device 321 are the same and the functionality described herein on the separate computing devices may be performed on a single device. The one or more software applications running on computing device 301 and computing device 321 may include natively installed and executed applications, browser-based applications, mobile applications, or any other applications suitable for development, operations, program managing, exposure control functionality, and the like. Software applications on computing device 301 and computing device 321 may execute in a stand-alone manner (as in the case of a natively installed application), within the context of another application (as in the case of a browser-based application), in an online collaborative context, in a combination of contexts, or in some other manner entirely.

Computing device 301, in the present example, is running a DevOps application with which a new service feature may be developed, identified, and/or deployed, as illustrated by environment 303. Once a new feature is created (i.e., feature 309), code base 307 is updated with the new feature and the update, including feature 309, is sent to all servers that may provide the service associated with code base 307.

Computing device 321, in the present example, is running a program manager application in which a new service feature may be enabled or disabled for individual servers, as well as metrics tool 323 that can be used for analyzing machine utilization metrics associated with the new feature. Once the update is distributed to all servers, feature 309 is turned on for group 311 from computing device 321, wherein group 311 represents a subset of servers for testing the COGS impact of feature 309, also referred to herein as the target group or treatment group. As previously described, group 311 may be a randomly selected group, or may be selected by a user of computing device 321 or different connected device. Group 311 may include any number of servers, including servers from the same datacenter or region or servers distributed across datacenters or regions. Group 313, alternatively, represents a control group, for which feature 309 remains turned off such that performance metrics can be compared between the groups.

Once the target group and control group are selected, performance information 325 (e.g., machine utilization metrics) is reported out by the machines in group 311 and similarly, performance information 327 is reported out by the machines in group 313. In different implementations, performance information 325 and/or performance information 327 may be reported back in real-time, near real-time, batch, or similar formats. In some embodiments, one or more trained machine learning models are utilized to generate a recommendation for improving the new feature based at least on performance information 325. In the present example, performance information 325 and performance information 327 are shown as reporting to computing device 321. However, performance information 325 and performance information 327 may be reported to alternative or additional computing devices, including but not limited to computing device 301.

In the present example, an end user device sends a request to machine 315 to complete one or more application processes, wherein machine 315 has feature 309 enabled. Thus, because the end user device uses a machine from group 311 to complete the one or more processes, the application includes feature 309, in addition to features already existing prior to the install of feature 309, as shown in user experience 331. Likewise, another end user device sends a request to machine 317 to complete or more application processes, wherein machine 317 has feature 309 disabled. Thus, because this end user device utilizes a machine outside of group 311 (in this case, group 313, the control group) to complete the one or more processes, the application does not include feature 309, as shown in user experience 331.

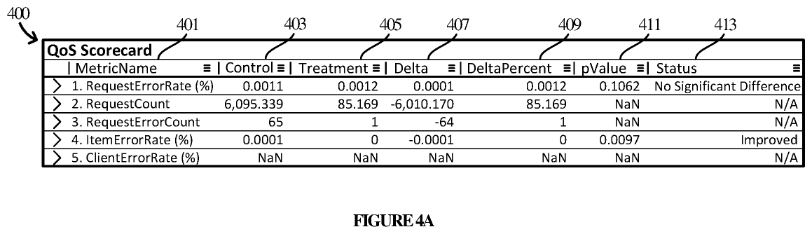

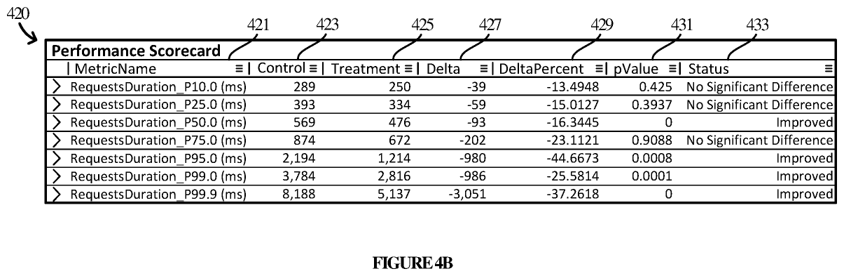

FIGS. 4A-4B illustrate examples of scorecards that may be produced as visualizations of QoS and performance metrics with respect to exposure control environment 100 and/or exposure control environment 300 Visualizations produced are not limited to QoS and performance scorecards, and may include many other types of visualizations and metrics including but not limited to additional metrics, different visualization formats (e.g., spreadsheets, graphs, charts, etc.), requests information, sessions information, utilization information, and the like. Additional metrics that may be collected and organized into visualizations for machine utilization analysis purposes include, as just a few examples, error rates, memory available, idle time, process thread count, number of requests, number of sessions, and other capacity optimization metrics that help understand how “hot” machines are running and how many machines are needed to run the service with good quality, as well as many other metrics.

FIG. 4A illustrates example QoS Scorecard 400, which serves as an example of a visualization of QoS metrics with respect to exposure control environment 100 and/or exposure control environment 300. QoS Scorecard 400 is associated with testing a feature rollout, which serves as an example of a visualization such as score card 111 or the visualization generated in step 207 of process 200. QoS Scorecard 400 is provided only for purposes of example—metrics may be presented in an entirely different manner and/or different or additional metrics may be included.

QoS Scorecard 400 includes column 401, “MetricName”; column 403, “Control”; column 405, “Treatment”; column 407, “Delta”; column 409, “DeltaPercent”; column 411, “pValue”; and column 413, “Status.” The metrics included in QoS Scorecard include RequestErrorRate, RequestCount, RequestErrorCount, ItemErrorRate, and ClientErrorRate. The values for the control group and the treatment group are provided in column 403 and column 405. Differences between the groups are provided in column 407, the percent difference is provided in column 409, and the p-value is provided in column 411. Importantly, column 413 provides the “status” for each metric, indicating the net effect that the new feature had based on a comparison of the control and treatment groups, wherein the status may be “no significant difference,” “improved,” or “worsened.”

FIG. 4B illustrates example Performance Scorecard 420, which serves as an example of a visualization of performance metrics with respect to exposure control environment 100 and/or exposure control environment 300. Performance Scorecard 420 is associated with testing a feature rollout, which serves as an example of a visualization such as score card 111 or the visualization generated in step 207 of process 200. Performance Scorecard 420 is provided only for purposes of example—metrics may be presented in an entirely different manner and/or different or additional metrics may be included.

Performance Scorecard 420 includes column 421, “MetricName”; column 423, “Control”; column 425, “Treatment”; column 427, “Delta”; column 429, “DeltaPercent”; column 431, “pValue”; and column 433, “Status.” The metrics included in Performance Scorecard include RequestsDuration_P10.0, RequestsDuration_P25.0, RequestsDuration_P50.0, RequestsDuration_P75.0, RequestsDuration_P95.0, RequestsDuration_P99.0, and RequestsDuration_P99.9. The corresponding values for the control group and the treatment group are provided in column 423 and column 425. Differences between the groups are provided in column 427, the percent difference is provided in column 429, and the p-value is provided in column 431. Importantly, column 433 provides the “status” for each metric, indicating the net effect that the new feature had based on a comparison of the control and treatment groups, wherein the status may be “no significant difference,” “improved,” or “worsened.”

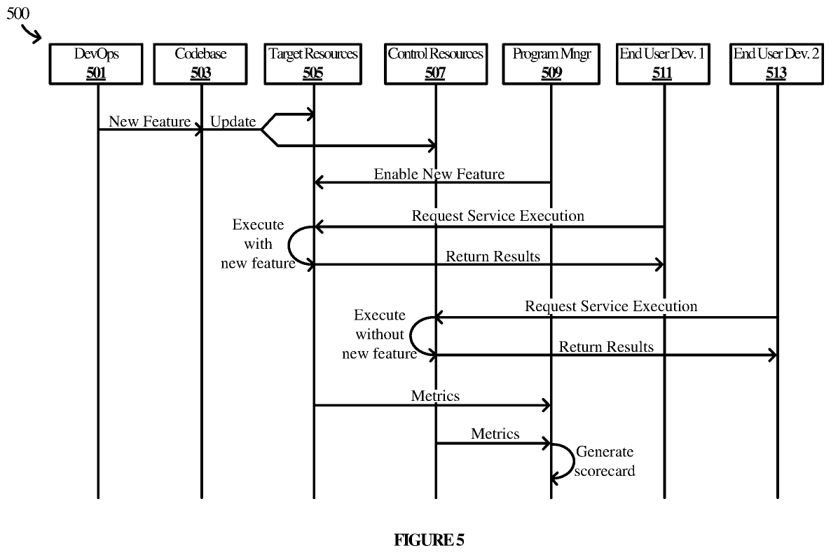

FIG. 5 illustrates operational scenario 500 in which the machine-based exposure control system in accordance with the present disclosure is implemented. Operational scenario includes DevOps 501, codebase 503, target resources 505, control resources 507, program manager 509, end user device one 511, and end user device two 513. DevOps 501 is representative of any computing device capable of developing or distributing a new feature to codebase 503 (e.g., computing device 101 or computing device 301). Codebase 503 is representative of the body of source code (e.g., code base 307) that may be run by at least target resources 505 and control resources 507 in executing service requests.

Target resources 505 is representative of a group of one or more machines (e.g., physical servers or virtual machines) on which the new feature (e.g., feature 309) is enabled (e.g., group 115 or group 311). Control resources 507 is representative of a group of one or more machines on which the new feature is not enabled (e.g., group 117 or group 313). Program manager 509 is representative of any computing device from which features can be enabled or disabled for target resources 505 and control resources 507 and on which a machine utilization scorecard can be generated (e.g., computing device 101 or computing device 321). Both DevOps 501 and program manager 509 may be representative of a single computing device or multiple computing devices on which all of the aforementioned functionality can be performed or spread across. End user device one 511 is representative of any end user device that sends a request for service to target resources 505 (e.g., end user devices 121) and end user device two 513 is representative of any end user device that sends a request for service to control resources 507 (e.g., end user devices 123).

In accordance with the present example, DevOps 501, after identifying a new feature for codebase 503, uploads the new feature to codebase 503. The update is then distributed to all resources that may utilize codebase 503 in responding to service requests, including target resources 505 and control resources 507. One the codebase is updated with the new feature on all devices, program manager 509 enables the new feature on target resources 505 only. On all other resources, the new feature remains disabled during the test period. End user device one 511 requests execution of a service from one or more resources of target resources 505. Upon receiving the request, the one or more resources execute the program corresponding to the request (i.e., from all or a portion of codebase 503), wherein the program includes the new feature. Upon completion, the one or more resources return the results to end user device one 511. End user device two 513 requests execution of a service from one or more resources of control resources 507. Upon receiving the request, the one or more resources execute the program corresponding to the request (i.e., from all or a portion of codebase 503), wherein the program does not include the new feature because it is not enabled for the resources. Upon completion, the one or more resources return the results to end user device two 513.

In accordance with the present disclosure, machine utilization and performance metrics may be utilized to analyze the COGS and QoS impact of the new feature. In an exemplary embodiment, the new feature may remain enabled on target resources 505 for a set period of time, over which the machine utilization and performance metrics are collected from both target resources 505 and control resources 507. The metrics as they are reported through the test period or may be reported at set intervals or entirely at the end of the test period. Once the metrics are reported back to program manager 509, program manager generates at least a scorecard based on the metrics (e.g., QoS Scorecard 400 and Performance Scorecard 420).

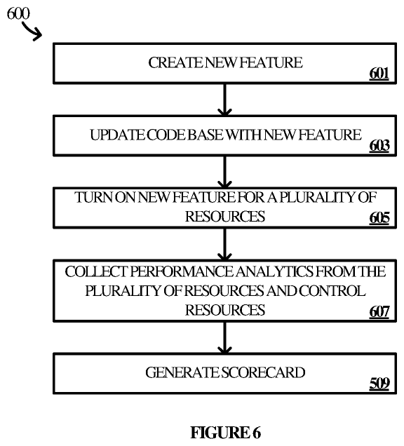

FIG. 6 illustrates process 600 that may be implemented on the front end of an exposure control system as described herein. Process 600 may be implemented in program instructions in the context of any of the software applications, modules, components, or other such elements of one or more computing devices. For example, process 600 may be employed by an application on computing device 101, computing device 301, computing device 321, or by an application running in the context of online service 113. The program instructions direct the one or more computing devices to operate as follows, referring to a computing device in the singular for purposes of clarity.

Process 600 includes step 601, in which a computing system creates a new feature (e.g., feature 309) developed in the context of a DevOps environment. In step 603, the computing system updates the corresponding code base (e.g., code base 307) with the new feature. In step 605, the computing device turns on the new feature for a plurality of resources (e.g., machines in group 115 or machines in group 311). In step 607, the computing device collects performance analytics (e.g., QoS, machine utilization, and/or service performance statistics) from the plurality of resources and a set of control resources (e.g., machines in group 117 or machines in group 313). In step 609, the computing device generates at least one scorecard or alternative presentation or visualization of the data (e.g., score card 111, QoS Scorecard 400, or Performance Scorecard 420) such that any QoS and COGs impacts from the new feature can be discovered and analyzed.

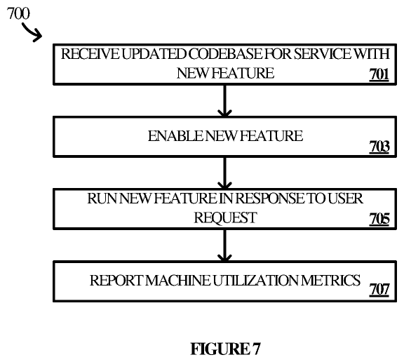

FIG. 7 illustrates process 700 that may be implemented in the back end of an exposure control system as described herein. Process 700 may be employed by one or more resources (e.g., servers, VMs, machines) of a target group having a new feature turned on. Process 700 may be implemented in program instructions in the context of any of the software applications, modules, components, or other such elements of one or more resources. For example, process 700 may be employed by one of the resources in group 115, group 311, or by another resource in the context of online service 113. The program instructions direct the one or more computing devices to operate as follows, referring to a resource in the singular for purposes of clarity.

Process 700 includes step 701, in which a resource receives an updated codebase (e.g., code base 307) for service a new feature (e.g., feature 309). In step 703, the resource, in response to an instruction to do so, enables the new feature such that devices accessing the resource (e.g., end user devices 121) may utilize the new feature. In step 705, the resource runs the new feature in response to a request from a user device. In step 707, the resource reports machine utilization metrics (e.g., performance information 325) out for COGs and QoS analysis in a DevOps or program managing environment or similar.

FIG. 8 illustrates computing system 801 to provide machine-based exposure control functionality according to an implementation of the present technology. Computing system 801 is representative of any system or collection of systems with which the various operational architectures, processes, scenarios, and sequences disclosed herein for providing machine-based exposure control functionality may be employed. Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements process 806, which is representative of any of the enhanced exposure control processes discussed with respect to the preceding Figures, including but not limited to operations for testing machine utilization impacts from feature rollouts. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including process 806) may be implemented in program instructions and among other functions may, when executed by processing system 802, direct processing system 802 to operate as described with respect to the various operational scenarios, sequences, and processes illustrated herein. For example, software 805 may include program instructions for deploying new features to target groups and comparing machine utilization metrics as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to provide enhanced exposure control functionality as described herein. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

The following provides additional exemplary implementations of the contents disclosed herein:

Example 1: A computing apparatus comprising one or more computer readable storage media, one or more processors operatively coupled with the one or more computer readable storage media, and program instructions stored on the one or more computer readable storage media. The program instructions, when executed by the one or more processors, direct the computing apparatus to at least: identify a new feature in a codebase, wherein the codebase has been updated with the new feature across multiple resources; enable the new feature for a target group of the multiple resources while keeping the new feature dormant for a control group of the multiple resources; collect performance information for the target group and the control group for a time period; and generate a visualization of one or more differences between the performance information for the target group and the performance information for the control group for the time period.

Example 2: The computing apparatus of example 1, wherein the program instructions further direct the computing apparatus to identify the target group and the control group from amongst the multiple resources.

Example 3: Any combination of examples 1 through 2, wherein the program instructions, to identify the target group and the control group from amongst the multiple resources, further direct the computing apparatus to randomly select one or more resources from the multiple resources for the target group.

Example 4: Any combination of examples 1 through 3, wherein the program instructions further direct the computing apparatus to receive, via a user interface, an instruction to deploy the new feature in a remainder of the resources, wherein the remainder of the resources comprises resources of the multiple resources that were not a part of the target group.

Example 5: Any combination of examples 1 through 4, wherein the performance information comprises machine utilization statistics for each resource in the target group.

Example 6: Any combination of examples 1 through 5, wherein the program instructions further direct the computing apparatus to provide the performance information for the target group and the control group to one or more machine learning models, wherein the one or more machine learning models are configured to generate a recommendation for improving the new feature based at least on the machine utilization statistics.

Example 7: Any combination of examples 1 through 6, wherein the program instructions further direct the computing apparatus to surface, in a user interface, the recommendation for improving the new feature.

Example 8: Any combination of examples 1 through 7, wherein the feature affects two or more services that utilize the codebase and the target group is spread across resources that provide a first service of the two or more services and a second service of the two or more services.

Example 9: A method comprising: identifying a new feature in a codebase, wherein the codebase has been updated with the new feature across multiple resources; enabling the new feature for a target group of the multiple resources while keeping the new feature dormant for a control group of the multiple resources; collecting performance information for the target group and the control group for a time period; and generating a visualization of one or more differences between the performance information for the target group and the performance information for the control group for the time period.

Example 10: The method of example 9, further comprising identifying the target group and the control group from amongst the multiple resources.

Example 11: Any combination of examples 9 through 10, wherein identifying the target group and the control group from amongst the multiple resources comprises randomly selecting one or more resources from the multiple resources for the target group.

Example 12: Any combination of examples 9 through 11, further comprising receiving, via a user interface, an instruction to deploy the new feature in a remainder of the resources, wherein the remainder of the resources comprises resources of the multiple resources that were not a part of the target group.

Example 13: Any combination of examples 9 through 12, wherein the performance information comprises machine utilization statistics for each resource in the target group.

Example 14: Any combination of examples 9 through 13, further comprising providing the performance information for the target group and the control group to one or more machine learning models, wherein the one or more machine learning models are configured to generate a suggestion for improving the new feature based at least on the machine utilization statistics.

Example 15: Any combination of examples 9 through 14, further comprising surfacing, in a user interface, the recommendation for improving the new feature.

Example 16: Any combination of examples 9 through 15, wherein the feature affects two or more services that utilize the codebase and the target group is spread across resources that provide a first service of the two or more services and a second service of the two or more services.

Example 17: One or more computer readable storage media having program instructions stored thereon. The computer readable storage media, when executed by one or more processors in a computing device, direct the computing device to at least: identify a new feature in a codebase, wherein the codebase has been updated with the new feature across multiple resources; enable the new feature for a target group of the multiple resources while keeping the new feature dormant for a control group of the multiple resources; collect performance information for the target group and the control group for a time period; and generate a visualization of one or more differences between the performance information for the target group and the performance information for the control group for the time period.

Example 18: The one or more computer readable storage media of example 17, wherein the program instructions further direct the computing device to identify the target group and the control group from amongst the multiple resources.

Example 19: Any combination of examples 17 through 18, wherein the program instructions, to identify the target group and the control group from amongst the multiple resources, further direct the computing device to randomly select one or more resources from the multiple resources for the target group.

Example 20: Any combination of examples 17 through 19, wherein the program instructions further direct the computing device to receive, via a user interface, an instruction to deploy the new feature in a remainder of the resources, wherein the remainder of the resources comprises resources of the multiple resources that were not a part of the target group.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of such productivity applications, they apply as well to other contexts such as gaming applications, virtual and augmented reality applications, business applications, and other types of software applications. Likewise, the concepts apply not just to electronic documents, but to other types of content such as in-game electronic content, virtual and augmented content, databases, and audio and video content.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
identify a new feature in a codebase, wherein the codebase has been updated with the new feature across multiple resources;
enable the new feature for a target group of the multiple resources while keeping the new feature dormant for a control group of the multiple resources;
collect performance information for the target group and the control group for a time period; and
generate a visualization of one or more differences between the performance information for the target group and the performance information for the control group for the time period.

2. The computing apparatus of claim 1, wherein the program instructions further direct the computing apparatus to identify the target group and the control group from amongst the multiple resources.

3. The computing apparatus of claim 2, wherein the program instructions, to identify the target group and the control group from amongst the multiple resources, further direct the computing apparatus to randomly select one or more resources from the multiple resources for the target group.

4. The computing apparatus of claim 1, wherein the program instructions further direct the computing apparatus to receive, via a user interface, an instruction to deploy the new feature in a remainder of the resources, wherein the remainder of the resources comprises one or more of the multiple resources that were not a part of the target group.

5. The computing apparatus of claim 1, wherein the performance information comprises machine utilization statistics for each of the resources in the target group.

6. The computing apparatus of claim 5, wherein the program instructions further direct the computing apparatus to provide the performance information for the target group and the control group to one or more machine learning models, wherein the one or more machine learning models are configured to generate a recommendation for improving the new feature based at least on the machine utilization statistics.

7. The computing apparatus of claim 6, wherein the program instructions further direct the computing apparatus to surface, in a user interface, the recommendation for improving the new feature.

8. The computing apparatus of claim 1, wherein the new feature affects two or more services that utilize the codebase and the target group is spread across resources that provide a first service of the two or more services and a second service of the two or more services.

9. A method comprising:
identifying a new feature in a codebase, wherein the codebase has been updated with the new feature across multiple resources;
enabling the new feature for a target group of the multiple resources while keeping the new feature dormant for a control group of the multiple resources;
collecting performance information for the target group and the control group for a time period; and
generating a visualization of one or more differences between the performance information for the target group and the performance information for the control group for the time period.

10. The method of claim 9, further comprising identifying the target group and the control group from amongst the multiple resources.

11. The method of claim 10, wherein identifying the target group and the control group from amongst the multiple resources comprises randomly selecting one or more resources from the multiple resources for the target group.

12. The method of claim 9, further comprising receiving, via a user interface, an instruction to deploy the new feature in a remainder of the resources, wherein the remainder of the resources comprises one or more of the multiple resources that were not a part of the target group.

13. The method of claim 9, wherein the performance information comprises machine utilization statistics for each of the resources in the target group.

14. The method of claim 13, further comprising providing the performance information for the target group and the control group to one or more machine learning models, wherein the one or more machine learning models are configured to generate a suggestion for improving the new feature based at least on the machine utilization statistics.

15. The method of claim 14, further comprising surfacing, in a user interface, the suggestion for improving the new feature.

16. The method of claim 9, wherein the new feature affects two or more services that utilize the codebase and the target group is spread across resources that provide a first service of the two or more services and a second service of the two or more services.

17. One or more computer readable storage media having program instructions stored thereon that, when executed by one or more processors in a computing device, direct the computing device to at least:
identify a new feature in a codebase, wherein the codebase has been updated with the new feature across multiple resources;
enable the new feature for a target group of the multiple resources while keeping the new feature dormant for a control group of the multiple resources;
collect performance information for the target group and the control group for a time period; and
generate a visualization of one or more differences between the performance information for the target group and the performance information for the control group for the time period.

18. The one or more computer readable storage media of claim 17, wherein the program instructions further direct the computing device to identify the target group and the control group from amongst the multiple resources.

19. The one or more computer readable storage media of claim 18, wherein the program instructions, to identify the target group and the control group from amongst the multiple resources, further direct the computing device to randomly select one or more resources from the multiple resources for the target group.

20. The one or more computer readable storage media of claim 17, wherein the program instructions further direct the computing device to receive, via a user interface, an instruction to deploy the new feature in a remainder of the resources, wherein the remainder of the resources comprises one or more of the multiple resources that were not a part of the target group.
